(19) United States
(12) Patent Application Publication
(10) Pub. No.: US 2002/0121767 A1
(43) Pub. Date: Sep. 5, 2002

(54) Two-component airbag cover having a soft touch feel

(76) Inventors: Darius J. Preisler, Macomb, MI (US); Jason Murar, Detroit, MI (US)

Correspondence Address: Welsh & Katz, Ltd., Jeffrey W. Salmon, 22nd Floor, 120 South Reverside Plaza, Chicago, IL, 60606, US

(21) Appl. No.: 09/797,277

(22) Filed: Mar. 1, 2001

(51) Int. Cl. B60R 21/16

(52) U.S. Cl. 280/728.3; 280/728.2; 280/743.2

(57) ABSTRACT

An airbag assembly, which comprises an airbag cover with a soft outer surface. The airbag cover has a front plate and a backing plate. The front plate is connected to the backing plate. A plurality of resilient fingers generally outwardly extend between the front plate and backing plate. The airbag cover is provided with a “soft touch” feel by, for example, varying the density of the resilient members per unit area of the front panel, varying the size of the resilient members, or forming the resilient members and front panel from a thermoplastic material having a particular durometer. It should be understood that the abstract of the disclosure is not intended to be and should not be found to be limiting to the scope of the claims contained in this application or in any patent issuing therefrom.

### FIELD OF THE INVENTION

The present invention generally relates to components such as airbag covers that are used in motor vehicle applications and, more particularly, to a novel airbag cover with an exterior surface having a soft touch feel.

### BACKGROUND OF THE INVENTION

Airbag covers for motor vehicles are relatively well known in the art, and typically are manufactured using thermoplastic in an injection molding and/or slush molding process. For example, U.S. Pat. No. 5,979,933 to Murar et al. discloses an automobile airbag cover assembly, which includes an airbag cover section. The patent states that the airbag cover section has a front panel, rear panel and side panels made out of thermoplastic, and formed through an injection molding process. The content of U.S. Pat. No. 5,979,933 is incorporated by reference into this application as if fully set forth herein.

In another example, U.S. Pat. No. 6,082,762 to Preisler et al discloses an airbag assembly with an airbag cover. The patent states that the airbag cover is manufactured out of a thermoplastic elastomer using an injection molding process. The patent states that the hardness durometer of the front panel plastic is in the range of about 20 Shore D to 100 Shore D and the flexural modulus of the invention is in the range of about 15,000 to 400,000 psi. The content of U.S. Pat. No. 6,082,762 is incorporated by reference into this application as if fully set forth herein.

In yet another example, U.S. Pat. No. 6,053,526 to Preisler et al., discloses an airbag cover assembly. The patent states that the airbag cover assembly has a relatively flexible thermoplastic airbag cover formed by injection molding with thermoplastic. In FIG. 3 of this patent, a pad with a thermoplastic top plate and a plurality of spaced ribs is shown. As seen in FIG. 6 of this patent, each rib extends generally across the inner surface of the plate. The patent states that the purpose of the ribs is to transmit pressure from the front outer surface of the cover to activate a switch.

Referring to FIG. 1, an airbag cover 4 that has a soft outer surface or skin 6 that is manufactured by a slush molding process is shown. The interior of the skin 6 is injected with PVC foam to provide a soft interior 8. Slush molding manufacturing techniques present a number of disadvantages such as, for example, the expense of the process, the fact that the process is labor intensive, and that it is difficult to control the dimensional variance of the airbag cover. Moreover, significant amounts of environmentally hazardous volatile organic compounds are released to atmosphere in connection the slush molding process.

The airbag covers disclosed in the above-referenced patents are suitable for their intended purposes. However, there is a need for an inexpensive airbag cover that has a soft touch feel.

### SUMMARY OF THE INVENTION

It is desirable to provide an airbag cover that includes a front plate, a backing plate, and a plurality of resilient members that extend between the front and back plates, and allow at least a portion of the front plate to be moved with respect to the backing plate. One aspect of the present invention is that an airbag cover is provided with a soft touch feel. The degree of softness of the feel is provided by, for example, forming the resilient members from a resilient material such as a thermoplastic material having a certain durometer, providing a certain density of resilient members per unit area of the front and backing plates, or varying the size of the resilient members.

Providing such an airbag cover has a number of distinct advantages. First, the release of volatile organic compounds into the environment is significantly reduced over the typical slush molding process. Second, the costs associated with manufacturing such an airbag cover are significantly reduced over conventional techniques. Third, such an airbag cover has a luxurious feel to the user.

Other features and advantages of the invention will become apparent from the description that follows.

### BRIEF DESCRIPTION OF DRAWINGS

The objects and advantages of the present invention will become more readily apparent to those of ordinary skill in the relevant art after reviewing the following detailed description and accompanying drawings, wherein:

FIG. 1 is a side, cross-sectional view of a prior art airbag assembly showing a two-component airbag cover with an injected foam interior;

FIG. 2 is a perspective view of an embodiment of the present invention, showing a cut-out view of the airbag cover and an exploded view of a restraint assembly that attaches the airbag cover to a vehicle;

FIG. 3 is a side cross-sectional view of an embodiment of the present invention, showing a two-component airbag cover;

FIG. 4 is a top view of a portion of an embodiment of the front panel shown in FIG. 1, wherein a plurality of resilient fingers are arranged in an array with a predetermined density per unit area; and

FIGS. 5A and 5B are partial side views of the cut-out portion of the airbag cover shown in FIG. 2 that illustrate an example of the soft touch feel of the airbag cover shown in FIGS. 2 and 3.

### DETAILED DESCRIPTION

While the present invention is susceptible of embodiment in various forms, there is shown in the drawings an embodiment of the present invention that is discussed in greater detail hereafter. It should be understood that the present disclosure is to be considered as an exemplification of the present invention, and is not intended to limit the invention to the specific embodiment illustrated. It should be further understood that the title of this section of this application (“Detailed Description Of The Invention”) relates to a requirement of the United States Patent Office, and should not be found to be limiting to the subject matter disclosed herein.

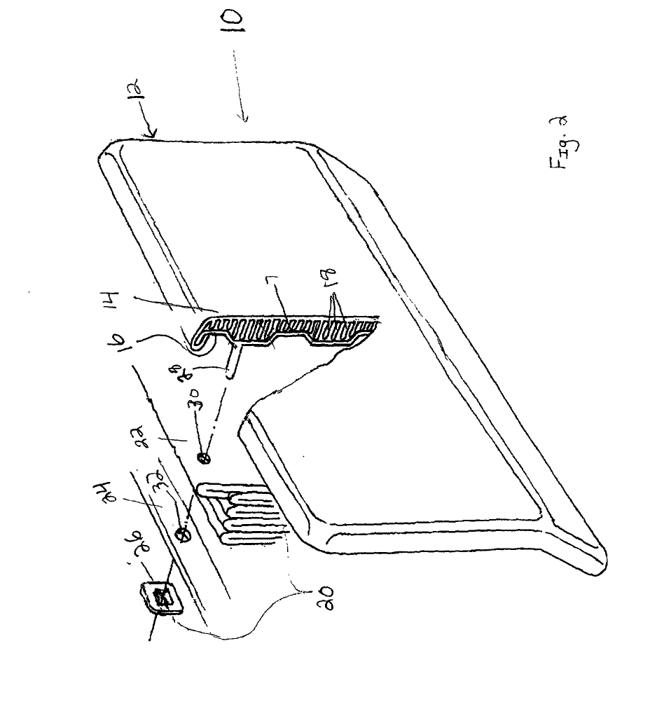

Referring now to FIG. 2, a perspective view of an airbag assembly 10 is shown. Airbag assembly 10 includes an airbag cover 12 that has a front panel 14 and a backing plate 16, both of which form an integral structure. Typically, the airbag cover 12 is encompassed in a steering assembly (not shown) and faces a vehicle's occupant. A plurality of resilient members 18 are connected to an interior surface of front panel 26 as shown in FIG. 2 that extend in a generally outward direction from the interior surface of the front panel 14. A distal end of each resilient member 18 contacts an interior surface of backing plate 16. Airbag cover 12 is provided with a soft touch feel by, for example, providing a predetermined density of the resilient members per unit area of the front plate 14, which may be enhanced by utilizing a resilient material of a particular durometer as discussed in greater detail hereafter.

It should be understood, however, that the resilient members 18 may extend outwardly in any desired direction away from the interior surface of the backing plate 16, whether in an angled manner or otherwise, or may be displaced from the backing plate 16 a certain distance without departing from the spirit and scope of the present invention.

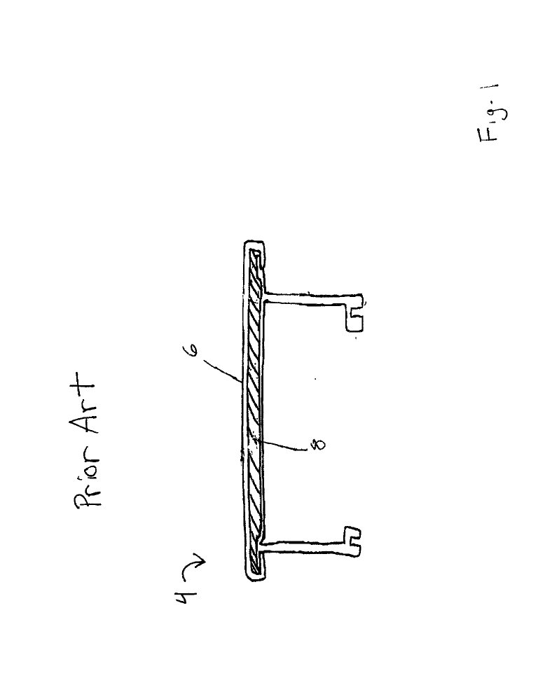

The airbag cover 12 is operatively connected to a restraint assembly 20 that prevents the airbag cover from striking and injuring a vehicle occupant when then airbag deploys. Assembly 20 comprises a tether 22, a retainer bar 24, and a push clip 26. The backing plate 16 has a stud 28 that generally outwardly extends from an exterior surface of the backing plate 16 as shown in FIG. 1. The stud 28 is inserted through an opening 30 in tether 22 and an opening 32 in retainer bar 24 to allow the tether to be operatively engaged to the airbag cover 12 via push clip 26. If desired, the backing plate 16 may include a plurality of studs 28 that are extended through additional openings in the tether 22 and the retainer bar 32 and that are secured by additional retainer clips (not shown) to provide strength to the attachment of the tether 22 to the airbag cover 12.

Referring now to FIG. 3, airbag assembly 34 with a two-component soft touch airbag cover 36, representing another embodiment of the present invention. The airbag assembly 34 includes a two-component airbag cover 36 that has a front panel 38 and a backing plate 40. A plurality of resilient members 42 extend generally outward from the front panel 38. In this embodiment of the invention, front panel 38 and backing plate 40 form a two-component assembly, and resilient members 42 are integrally formed as a portion of front panel 38. However, it should be understood that, for example, front panel 38 and backing plate 40 may be integrally formed as a portion of each other.

In the embodiment of the invention illustrated in FIG. 3, the resilient members 42 are interposed between the front panel 38 and backing plate 40 in a manner such that the resilient members 42 engage the backing plate 40. However, it should be understood that a distal end of the resilient member 42 may be disposed adjacent to a surface of the backing plate 40 without departing from the spirit or scope of the present invention.

The front panel 38 and backing plate 40 are connected by a tongue-groove attachment 44. In this embodiment of the invention, an interior surface of the front panel 38 includes a groove portion 46, and an interior surface of the backing plate 40 includes a tongue 48. The backing plate 40 includes a first bracket 50 and a second bracket 52 that allow the airbag assembly 34 to be attached to a corresponding mounting portion of a vehicle. The brackets 50 and 52 provide also stabilizing support to the airbag cover 36.

In the embodiment of the invention illustrated in FIG. 3, a tear seam 54 is formed in the first bracket 50. As the tear seam 54 is formed on an interior surface of the first bracket 50, the airbag cover 36 has a Class “A” surface that is suitable for aesthetic purposes in the vehicle interior. When the airbag (not shown) is deployed, the pressure that is applied to the airbag cover 36 by the expanding airbag causes the tear seam 54 to break as readily apparent to those of ordinary skill in the relevant art.

One aspect of the present invention is that airbag cover 36 includes a living hinge that is provided in the second bracket 52 at location 56. The living hinge replaces the restraint assembly 20 shown in FIG. 1, and causes the airbag cover 36 to rotate about the axis of the hinge when the airbag (not shown) deploys, thereby preventing the airbag cover from striking and injuring a vehicle's occupant. In an exemplary embodiment of the present invention, the living hinge is provided by crimping a portion of the second bracket 56 to a sufficient depth so that the second bracket 52 does not break when the airbag deploys.

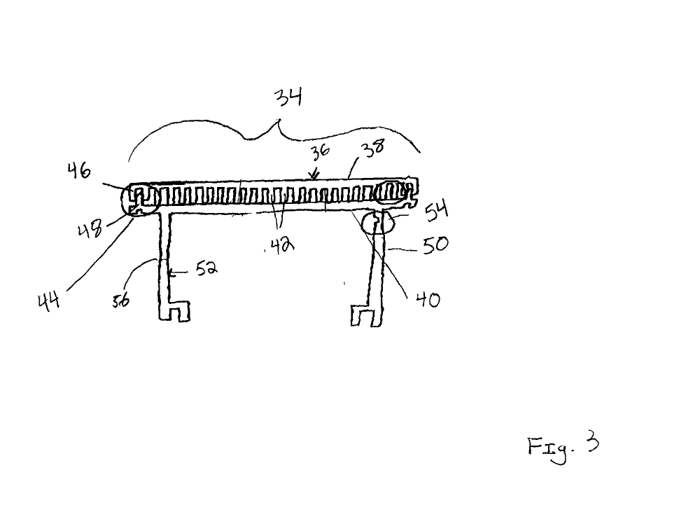

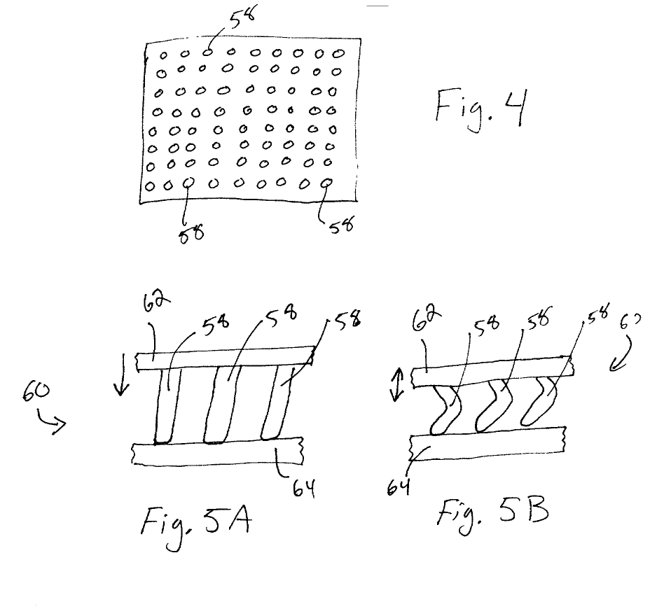

Referring to FIG. 4, a top view of a portion of an embodiment of the front panel shown in FIG. 1 is illustrated, wherein a plurality of resilient fingers 58 are arranged in an array with a predetermined density per unit area. FIGS. 5A and 5B are partial side views of an airbag cover 60 that illustrate an example of how the soft touch feel of the airbag cover shown in FIGS. 2 and 3.

The resilient members 58 provide airbag cover 60 with a soft feel when touched by an occupant of a vehicle. For example, when an airbag cover is touched by an occupant of a vehicle, pressure is applied to exterior surface of front panel 62. At least some of the pressure applied to the exterior surface of front panel 62 is transferred to the resilient members 58. When this occurs, the resilient members 58 deform as shown in FIG. 5B, thereby allowing the front panel 62 to be moved with respect to the backing plate 64 and indent the exterior surface of the front panel 62. The slight indentation provides the hand with a soft touch feel.

The degree of the soft touch feel to the front panel 62 is controlled by, for example, varying the size of the resilient members 58, or by varying the density of the resilient members 58 per unit area of the front plate 62. Also, the front panel 62 and resilient members 58 can be made from a suitable material such as a thermoplastic with a particular durometer to enhance the “softness” of the feel.

From the foregoing it will be observed that numerous modifications and variations can be effectuated without departing from the true spirit and scope of the novel concepts of the present invention. For example, while the embodiments of the present invention disclosed herein concern certain aspects of airbag cover technology for use in automobile applications, it should be appreciated and understood that the present invention is applicable to automotive applications other than airbag covers such as, for example, dash boards, vehicle interiors, and the like where it is desired to provide the surfaces of such components with a soft touch feel.

It is to be understood that no limitation with respect to the specific embodiments illustrated is intended or should be inferred. The disclosure is intended to cover by the appended claims all such modifications as fall within the scope of the claims when the claims are properly interpreted.

What is claimed is:

1. An assembly, comprising:
a front plate;
a backing plate that is operatively engaged with said front plate to define a space therebetween; and
a plurality of resilient members that are disposed in said space, said resilient members being fixedly attached to one of said front plate and said backing plate, said resilient members allowing at least a portion of said front plate to be moved with respect to said backing plate to provide a soft touch feel.

2. The assembly of claim 1, wherein said resilient members are integrally formed as a portion of said front plate.

3. The assembly of claim 2, wherein said resilient members and said front plate are formed from a moldable material.

4. The assembly of claim 3 wherein said moldable material comprises a thermoplastic material having a predetermined durometer.

5. The assembly of claim 1, wherein said resilient members are disposed in said space to have a predetermined density per unit area of said front plate.

6. The assembly of claim 1, wherein said resilient members have a predetermined size.

7. The assembly of claim 1, further comprising a restraint assembly.

8. The assembly of claim 7, wherein said restraint assembly includes a tether for generally preventing said front plate from contacting an occupant of a vehicle.

9. The assembly of claim 7, wherein said restraint assembly includes a living hinge.

10. The assembly of claim 9, wherein said front plate includes at least one support bracket, and wherein said living hinge comprises a seam formed in said at least one support bracket.

11. The assembly of claim 1, wherein said assembly comprises an airbag cover.
